(19) United States
(12) Patent Application Publication
(10) Pub. No.: US 2005/0115230 A1
(43) Pub. Date: Jun. 2, 2005

(54) Auxiliary airflow booster of engine

(76) Inventor: Tsung Jang Shi, Taichung Hsien (TW)

Correspondence Address: TSUNG JANG SHI, 235 Chung-Ho, Box 8-24, Taipei, TW

(21) Appl. No.: 10/725,086

(22) Filed: Dec. 2, 2003

(51) Int. Cl. F01N 1/02; F01N 7/00; F02B 27/02; F01N 3/10

(52) U.S. Cl. 60/312; 60/308; 60/324; 181/249

(57) ABSTRACT

An engine with an auxiliary airflow booster is installed to an exhausting tube at an exhausting gate of the exhausting head of a cylinder. The auxiliary airflow booster is a hollow body. An inner wall of the auxiliary airflow booster is formed with a narrowing portion which has two opposite tapered surfaces so as to have a front via hole and a rear via hole. The front via hole has a front tapered portion and the rear via hole has a rear tapered portion. An inner diameter of the front via hole is smaller than that of the rear via hole. Since the inner diameter of the rear via hole is larger than that of the front via hole, the rear via hole expands the diameter of the body. By above structure, the exhausting speed of waste gas is increased so that more fresh air is sucked into the cylinder.

### FIELD OF THE INVENTION

The present invention relates to engine components, and particular to an engine with an auxiliary airflow booster, in that, the exhausting speed of waste gas is increased so that more fresh air is sucked into the cylinder.

### BACKGROUND OF THE INVENTION

With reference to FIG. 1, the prior art engine structure is illustrated. The engine is formed by a cylinder 10 having a combustion chamber 101. A crank 18 and a piston 17 are installed in the combustion chamber 101. An air inlet gate 110 of the air inlet head 11 and an exhausting gate 120 of an exhausting head 12 are formed at an upper side of the piston. The air inlet head 11 is assembled with an air inlet tube 111 for inputting fresh air. The exhausting tube 19 is assembled to the exhausting head 12 for exhausting waste gas. The air inlet gate 110 is assembled with an air inlet gate 13, a spring 14, a camshaft 15a and the exhausting gate 120 is assembled with an air output gate 16, a spring 14 and a camshaft 15b. In other words, input air is mixed with fuel in the combustion chamber 101 and then burns. Thereby, the air inlet gate 13 is opened, and the air outlet gate 16 is closed. When waste gas is exhausted, the air inlet gate 13 is closed and the exhausting gate 16 is opened.

Furthermore, when input air is combusted, at an instant that the two gates are opened at the same time is formed, namely, the air inlet gate is opened, and the exhausting gate is still opened before closing. This is so called air gate overlapping time period. The length of the overlapping time period has the following effects:

If the air inlet gate is opened quickly (that is, opening of the gate is larger), then the exhausting gate will be opened lately so that more fresh air burns. Thus, CO and CO2 in the waste gas are reduced. Thereby, such way is only suitable for low rotation speed (rotation of the crank) instead of high rotation speed machine. This is because the exhausting time period is shorter than air inlet time period. Thereby, a natural flow will generate, namely, the waste gas is recycled so that the speed of the cylinder will be reduced. To compensate this defect, more fuel is necessary.

On the contrary, when the air inlet gate is opened in a short time period (that is opening of the gate is small), opening time of the exhausting gate is longer than that of the air inlet gate. Although the cylinder can be speeded transiently and thus less air is inputted, the combustion rate is low. Thereby, some fuel is wasted, that is, the fuel cannot be used effectively.

### SUMMARY OF THE INVENTION

Accordingly, the primary object of the present invention is to provide an engine with an auxiliary airflow booster which is installed to an exhausting tube at an exhausting gate of the exhausting head of a cylinder. The auxiliary airflow booster is a hollow body. An inner wall of the auxiliary airflow booster is formed with a narrowing portion which comprises two opposite tapered surfaces so as to have a front via hole and a rear via hole. The front via hole has a front tapered portion and the rear via hole has a rear tapered portion. An inner diameter of the front via hole is smaller than that of the rear via hole. Since the inner diameter of the rear via hole is larger than that of the front via hole, the rear via hole expands the diameter of the body. By above structure, the exhausting speed of waste gas is increased so that more fresh air is sucked into the cylinder.

The various objects and advantages of the present invention will be more readily understood from the following detailed description when read in conjunction with the appended drawing.

### BRIEF DESCRIPTION OF THE DRAWINGS

FIG. 1 is a schematic view about a prior art cylinder.

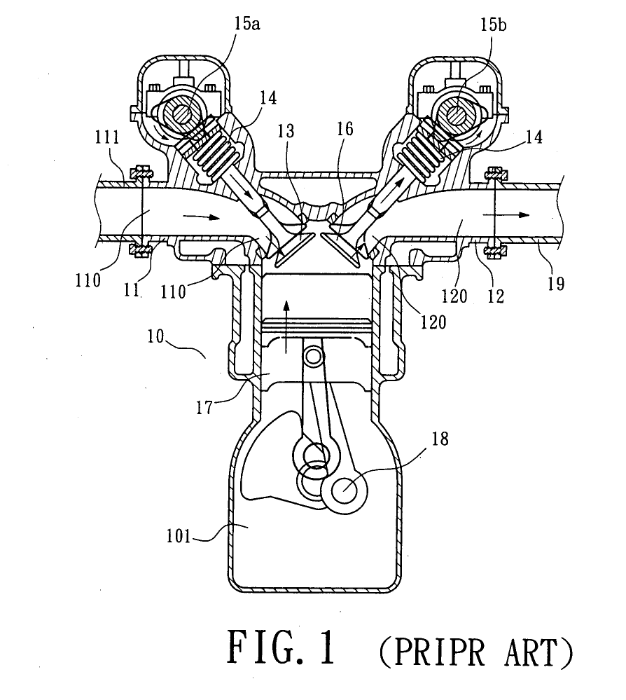

FIG. 2 is a schematic perspective view of the present invention.

FIG. 3 is a cross section view showing the arrangement of the present invention.

FIG. 4 is a partial cross section view showing the arrangement of the present invention.

FIG. 5 shows the auxiliary cover of the present invention; (A) is the exploded cross section view thereof and (B) is the assembled cross section view thereof.

FIG. 6 shows that an exhausting head is connected to the present invention, where (A) is a cross sectional view thereof and (B) is the assembled cross section view thereof.

FIG. 7 shows that the present invention is integrally formed with an exhausting head of a cylinder.

FIG. 8 is a cross section view showing that a plurality of bodies are assembled together.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

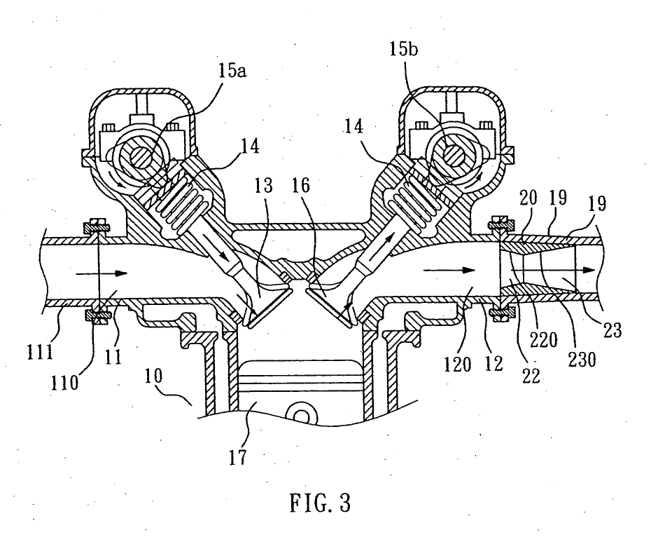

Referring to FIG. 3, an engine structure is illustrated. The engine is formed by a cylinder 10 having a combustion chamber. A piston 17 is installed in the combustion chamber. An air inlet head 11 has an air inlet gate 110 and is formed at an upper inlet side of the piston. The air inlet head 11 is assembled with an air inlet tube 111 for inputting fresh air. The air inlet gate 110 is assembled with an air inlet 13, a spring 14, a camshaft 15a. An exhausting head 12 has an exhausting gate 120 and is formed at an upper outlet side of the piston 17. An exhausting tube 19 is assembled to the exhausting head 12 for exhausting waste gas. The exhausting gate 120 is assembled with an air output gate 16, a spring 14 and a camshaft 15b. In other words, input air is mixed with fuel in the combustion chamber and then burns. Thereby, the air inlet gate 13 is opened, and the air outlet gate 16 is closed. When waste gas is exhausted, the air inlet gate 13 is closed and the exhausting gate 16 is opened.

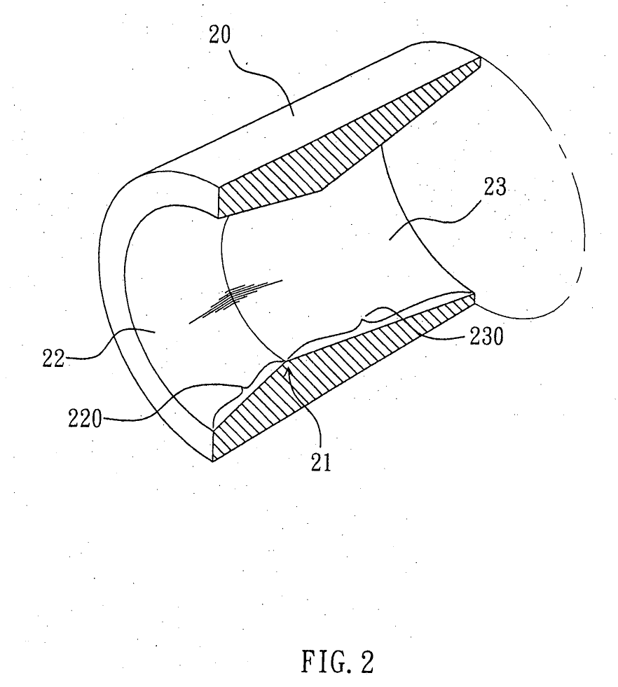

With reference to FIGS. 2, 3 and 4, an auxiliary airflow booster is added to an exhausting tube 19 at an exhausting gate 120 of the exhausting head 12 of a cylinder 10. The airflow booster is a hollow body 20. An inner wall thereof is formed with a narrowing portion 21 which comprises two opposite tapered surfaces so as to have a front via hole 22 and a rear via hole 23. The front via hole 22 has a tapered portion 220 and the rear via hole 23 has a tapered portion 230. An inner diameter φ1 of the front via hole 22 is smaller than the inner diameter φ2 of the rear via hole 23. In other words, the narrow portions of the tapered portion 220 and tapered portion 230 are connected. Since the inner diameter φ2 of the rear via hole 23 is larger than the inner diameter φ2 of the front via hole 22, the rear via hole 23 expands the diameter of the body 20.

In assembly, the body is enforced into the exhausting tube 19. Waste gas is inputted from the front via hole 22 and is then outputted from the rear via hole 23. When the waste gas passes through the front via hole 22 and rear via hole 23, the air is speeded. Thereby, the airflow booster acts like a Venturi tube. From Bernoulli's theorem,
Q(flow rate)=φ1(cross section of the front via hole)×V1(flow speed)=φ2(cross section of rear via hole)×V2(flow speed)

Thereby, under same flow rate (Q), when waste gas passes through the front via hole, φ1 reduced, so that the flow speed V1 increases. Thus, the present invention has the effect of increasing flow speed. This will enforce the speed of the exhausting air increases and thus the exhausting rate is also increased to induce a vacuum absorption effect. Thereby, air inputted to the air inlet gate 110 will increase.

Thereby, in the air gate overlapping time period (i.e., a period that the air inlet gate is opened, and the exhausting gate is opened). The rates for exhausting air and air absorption are increased. Thus, the recycle of waste gas is reduced because the exhausting air is increased. As a result fresh air inputted to the cylinder is increased so that the combustion rate is increased. This action is only executed at the air gate over lapping time period, and it is impossible too much air to be absorb into the cylinder. When comparing with the prior art, the present invention can speed the machine equipped the cylinder with the same gas.

Other embodiments of the present invention will be described herein.

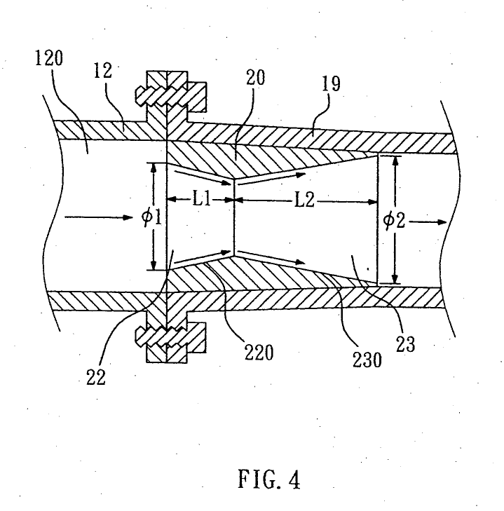

Referring to FIG. 4, the length L1 of the tapered portion 220 of the front via hole 22 is shorter than the length L2 of the tapered portion 230 of the rear via hole 23. Preferably, the length L1 is one half of length L2.

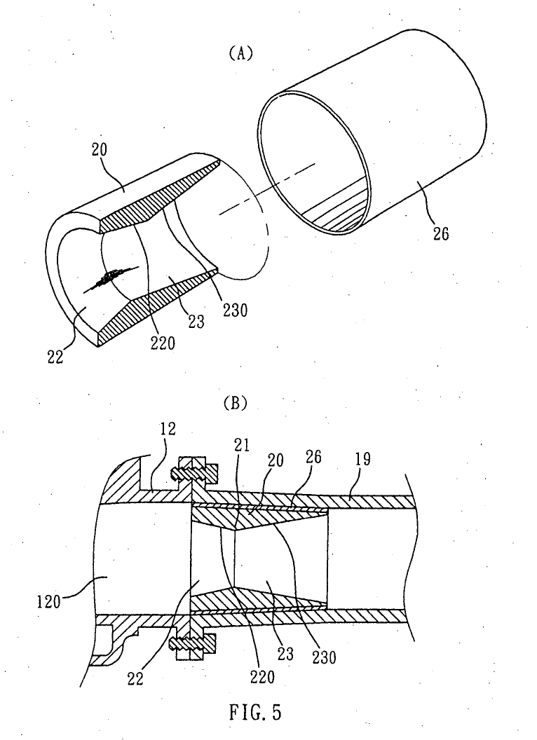

Referring to FIGS. 5(A) and 5(B), other than metal material, ceramic material can be used in the body 20. An auxiliary cover 26 covers the periphery thereof. Then the body 20 is enforced into the exhausting tube 19.

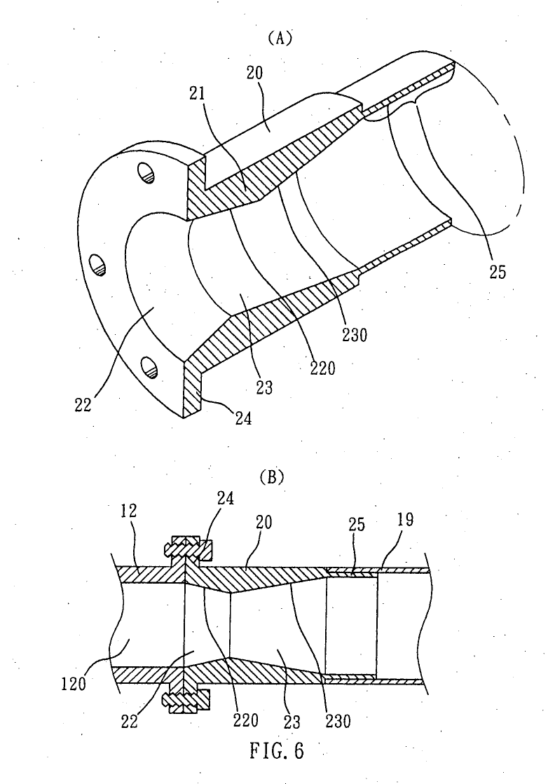

Referring to FIGS. 6(A) and 6(B), a locking sheet 24 is formed at a front end of the body 20 for locking the exhausting head 12 at the exhausting gate 120 of the cylinder 10, and a rear end thereof is installed with a connecting section 25 for engaging the exhausting tube 19.

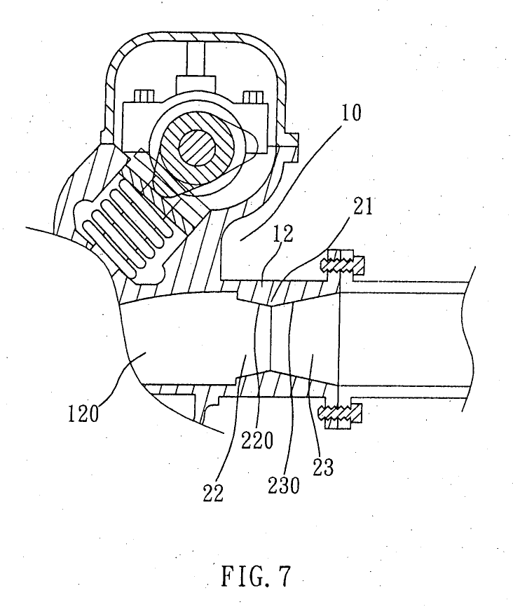

Referring to FIG. 7, an integral formed narrowing portion 21 with two tapered portions are installed at the wall of the exhausting gate 120 of the exhausting head 12 of the cylinder 10, wherein the inner diameter of the tapered portion 220 of the front via hole 22 is smaller than the inner diameter of the tapered portion 230 of the rear via hole 23. This gets the same effect.

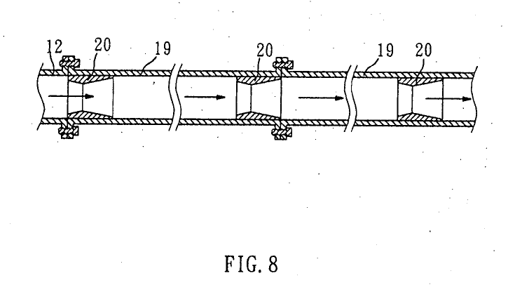

With reference to FIG. 8, at least one body 20 is assembled to the exhausting tube 19, for example, three exhausting tubes which are connected in series so as to enhance the effect of exhaustion.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-7. (canceled)

8. An engine with an auxiliary airflow booster, comprising:
a cylinder having a combustion chamber; a piston being installed in the combustion chamber;
an air inlet head having an air inlet gate and being formed at an upper inlet side of the piston; the air inlet head being assembled with an air inlet tube for inputting fresh air; the air inlet gate being assembled with an air inlet, a spring, and a camshaft;
an exhausting head having an exhausting gate and being formed at an upper outlet side of the piston; an exhausting tube being assembled to the exhausting head for exhausting waste gas; the exhausting gate being assembled with an air output gate, a spring and a camshaft, wherein input air is mixed with fuel in the combustion chamber and then burns, the air inlet gate is opened, and the air outlet gate is closed; when waste gas is exhausted, the air inlet gate is closed and the exhausting gate is opened;
an exhausting tube connected to the exhausting head;
an auxiliary airflow booster installed to the exhausting tube at an exhausting gate of the exhausting head; the auxiliary airflow booster being a hollow body; an inner wall of the auxiliary airflow booster being formed with a narrowing portion which comprises two opposite tapered surfaces so as to have a front via hole and a rear via hole; the front via hole having a front tapered portion and the rear via hole having a rear tapered portion; an inner diameter of the front via hole being smaller than the inner diameter of the rear via hole; namely, the narrow portions of the front tapered portion and rear tapered portion being connected; since the inner diameter of the rear via hole being larger than the inner diameter of the front via hole, the rear via hole expanding the diameter of the body; by above structure, the exhausting speed of waste gas is increased so that more fresh air is sucked into the cylinder.

9. The engine with an auxiliary airflow booster as claimed in claim 8, wherein the length of the front tapered portion of the front via hole is shorter than that of the rear tapered portion of the rear via hole.

10. The engine with an auxiliary airflow booster as claimed in claim 8, wherein the material of the body is selected from one of metals and ceramics.

11. The engine with an auxiliary airflow booster as claimed in claim 8, wherein an auxiliary cover covers the periphery of the body.

12. The engine with an auxiliary airflow booster as claimed in claim 8, wherein a locking sheet is formed at a front end of the body for locking the exhausting head at the exhausting gate of the cylinder, and a rear end thereof is installed with a connecting section for engaging the exhausting tube.

13. The engine with an auxiliary airflow booster as claimed in claim 8, wherein an inner wall of the exhausting gate of the exhausting head of a cylinder is formed with a narrowing portion which comprises two opposite tapered surfaces so as to have a front via hole and a rear via hole; the front via hole has a front tapered portion and the rear via hole has a rear tapered portion.

14. The engine with an auxiliary airflow booster as claimed in claim 8, wherein at least one body is installed in the exhausting tube.
